(19) United States
(12) Patent Application Publication
(10) Pub. No.: US 2010/0110400 A1
(43) Pub. Date: May 6, 2010

(54) SCANNING EXPOSURE APPARATUS, CONTROL METHOD THEREFOR, AND DEVICE MANUFACTURING METHOD

(75) Inventor: Takanori Sato, Utsunomiya-shi (JP)

Correspondence Address: CANON U.S.A. INC. INTELLECTUAL PROPERTY DIVISION, 15975 ALTON PARKWAY, IRVINE, CA, 92618-3731, US

(73) Assignee: CANON KABUSHIKI KAISHA, Tokyo (JP)

(21) Appl. No.: 12/613,358

(22) Filed: Nov. 5, 2009

(30) Foreign Application Priority Data
Nov. 6, 2008 (JP) 2008-285706

(51) Int. Cl. G03B 27/42; G01B 11/02

(52) U.S. Cl. 355/53; 356/498

(57) ABSTRACT

An apparatus which includes a measurement device measuring a surface position of a substrate at each of a plurality of measurement points; which is configured to scan-expose the substrate using slit-shaped light while controlling the surface position based on the measurement result; and in which a width, in a non-scanning direction of the substrate, of a region where the plurality of measurement points are arranged is wider than a width of the slit-shaped light, comprises a controller configured to control the measurement device so as to measure the surface positions in at least two shot regions on the substrate at once at the measurement points, at each of which a portion whose distance from a measurement target position on the substrate falls within a tolerable distance can be measured, of the plurality of measurement points.

### BACKGROUND OF THE INVENTION

1. Field of the Invention

The present invention relates to a scanning exposure apparatus, a control method therefor, and a method of manufacturing a device using the scanning exposure apparatus.

2. Description of the Related Art

An exposure apparatus is employed in a lithography process for manufacturing devices such as a semiconductor device, a display device, and a magnetic head device. The exposure apparatus projects the pattern of an original (also called a mask or a reticle) onto a substrate by a projection optical system to expose the substrate.

Along with miniaturization and an increase in packing density of integrated circuits, an exposure apparatus is used to project the pattern of an original onto a substrate at a high resolution. The resolution of an exposure apparatus depends on the exposure wavelength and the numerical aperture (NA) of a projection optical system. Under the circumstance, various efforts are underway to increase the NA of the projection optical system and to shorten the exposure wavelength.

Such exposure apparatuses include an exposure apparatus (a so-called stepper) which exposes a substrate while an original and the substrate stand still, and a scanning exposure apparatus (a so-called scanner) which exposes a substrate with slit-shaped light while scanning an original and the substrate with respect to a projection optical system.

Since a scanner (scanning exposure apparatus) can scan a substrate while controlling the surface position of the substrate to be aligned with an optimal image plane position for exposure, it is less adversely affected by the substrate flatness. Also, a scanner can increase the NA and the size of the exposure region while using a projection optical system equivalent to that used in a stepper. Under the circumstance, a scanner has naturally become a mainstream exposure apparatus.

A scanner measures the surface position of a substrate while scanning it. This measurement can employ, for example, a light oblique incidence sensor or a gap sensor such as an air microsensor or a capacitance sensor.

To measure not only the surface position (level) but also the surface tilt, a plurality of measurement points are arranged in the non-scanning direction perpendicular to the scanning direction. At least two shot regions in the non-scanning direction can be measured at once by one scanning by arranging a plurality of measurement points across a region that falls outside the width of slit-shaped light in the non-scanning direction (or the width of a shot region in the non-scanning direction), as shown in FIG. 4. This shortens the time taken to measure the surface positions in all shot regions.

In the conventional measurement method, deviations may occur between measurement target positions and actual measurement portions unless the arrangement of shot regions on the substrate conforms to the distance at which measurement points are arranged on a measurement device in the non-scanning direction. FIG. 4 illustrates deviations that may occur between measurement target positions and actual measurement portions. Referring to FIG. 4, measurement target positions 402, 403, 408, and 409 in the X direction (non-scanning direction) match the positions of measurement points 410, 411, 415, and 416 in the X direction. However, measurement target positions 404 to 407 in the X direction differ from the positions of measurement points (i.e., 412, 413, and 414) in the X direction. Japanese Patent Laid-Open No. 9-45608 describes that deviations between measurement target positions and actual measurement positions cause measurement errors attributed to the repeating pattern on the substrate, resulting in substrate defocus from the image plane during substrate exposure. This accounts for a resolution failure attributed to defocus in a process in which a sufficient margin cannot be ensured for the depth of focus.

### SUMMARY OF THE INVENTION

One of the aspect of the present invention provides an apparatus which includes a measurement device that measures a surface position of a substrate at each of a plurality of measurement points; which is configured to scan and expose the substrate using slit-shaped light while controlling the surface position based on the measurement result; and in which a width, in a non-scanning direction of the substrate, of a region where the plurality of measurement points are arranged is wider than a width of the slit-shaped light, the apparatus comprising a controller configured to control the measurement device so as to measure the surface positions in at least two shot regions on the substrate at once at the measurement points, at each of which a portion whose distance from a measurement target position on the substrate falls within a tolerable distance can be measured, of the plurality of measurement points.

Further features of the present invention will become apparent from the following description of exemplary embodiments with reference to the attached drawings.

### BRIEF DESCRIPTION OF THE DRAWINGS

FIG. 1 is a view showing the schematic arrangement of a scanning exposure apparatus according to an embodiment of the present invention;

FIG. 2 is a view illustrating the arrangement of shot regions on a substrate;

FIG. 3 is a view showing an example of the arrangement of measurement points;

FIG. 4 is a view illustrating the relationship between measurement target positions and measurement points in the non-scanning direction;

FIG. 5 is a flowchart schematically showing the operation of a scanning exposure apparatus EX shown in FIG. 1;

FIG. 6 is a view for explaining a method of determining shot regions, in the non-scanning direction, where the surface positions are measured at once by one scanning;

FIG. 7 is a view for explaining the method of determining shot regions, in the non-scanning direction, where the surface positions are measured at once by one scanning;

FIG. 8 is a view for explaining the method of determining shot regions, in the non-scanning direction, where the surface positions are measured at once by one scanning;

FIG. 9 is a view for explaining the method of determining shot regions, in the non-scanning direction, where the surface positions are measured at once by one scanning; and

FIG. 10 is a view for explaining the method of determining shot regions, in the non-scanning direction, where the surface positions are measured at once by one scanning.

### DESCRIPTION OF THE EMBODIMENTS

Embodiments of the present invention will be described below with reference to the accompanying drawings.

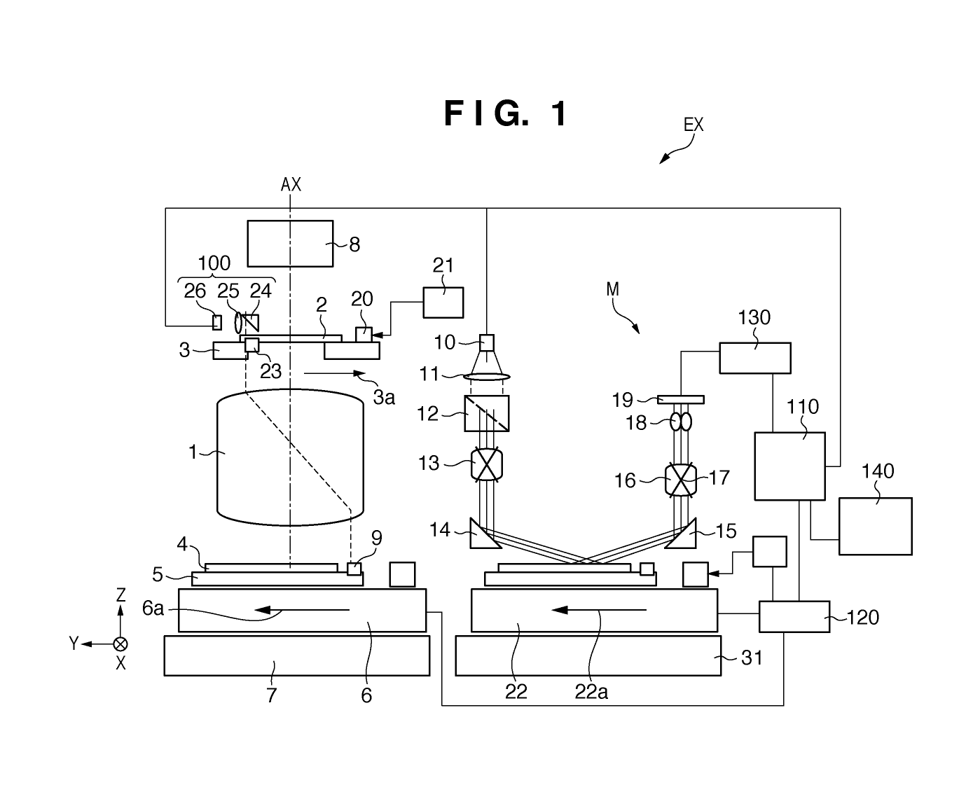

FIG. 1 is a view showing the schematic arrangement of a scanning exposure apparatus according to an embodiment of the present invention. A scanning exposure apparatus EX according to an embodiment of the present invention includes a measurement device M which measures the surface position of a substrate at each of a plurality of measurement points. The scanning exposure apparatus EX is configured to scan and expose the substrate using slit-shaped light while controlling the surface position of the substrate based on the measurement result obtained by the measurement device M.

The width, in the non-scanning direction (X direction) perpendicular to the scanning direction (Y direction) of the substrate, of a region where the plurality of measurement points are arranged is wider than that of the slit-shaped light in the non-scanning direction (X direction). The width, in the non-scanning direction (X direction), of the region where the plurality of measurement points are arranged is, for example, twice or more times that (i.e., the width of a maximum shot region) of the slit-shaped light in the non-scanning direction (X direction) perpendicular to the scanning direction (Y direction) of the substrate.

The scanning exposure apparatus EX may include a measurement station and exposure station. The measurement station is used to measure a substrate using the measurement device M. The exposure station is used to expose the substrate under the control based on the measurement result obtained by the measurement device M. A substrate stage which holds the substrate measured by the measurement device M moves from the measurement station to the exposure station. In the exposure station, the substrate is exposed under the control based on the measurement result obtained by the measurement device M. The scanning exposure apparatus EX includes two substrate stages 6 and 22. The scanning exposure apparatus EX parallelly performs measurement in the measurement station and exposure in the exposure station while repeatedly swapping the two substrate stages 6 and 22.

In the exposure station, an original (reticle) 2 is held on an original stage (reticle stage) 3, and the pattern of the original 2 is reduced and projected by a projection optical system 1 onto a substrate (e.g., a wafer) 4 located on the image plane of the projection optical system 1.

The substrate 4 having its surface coated with a photosensitive agent (photoresist) has a plurality of shot regions arranged on it. The substrate 4 is held by a substrate chuck 5. The substrate chuck 5 is driven by the substrate stage 6. The substrate stage 6 controls, for example, the six axes of the substrate chuck 5 (substrate 4). In the exposure station, the substrate stage 6 (or the substrate stage 22) moves on a base 7 (or the base 31).

The measurement device M is disposed in the measurement station. The measurement device M measures the substrate surface position and tilt. The measurement device M can include, for example, components 10 to 19. A light source 10 includes, for example, a white light lamp or a high-intensity light-emitting diode having a plurality of different peak wavelengths. A collimator lens 11 converts light supplied from the light source 10 into a collimated light beam having a nearly uniform cross-sectional intensity distribution, and outputs it. A slit member 12 is formed by coupling the slopes of a pair of prisms through a light-shielding film which has a plurality of openings (e.g., 25 pinholes) and is made of, for example, chromium. A bilateral telecentric optical system 13 guides a plurality of (e.g., 25) independent light beams having passed through the plurality of pinholes in the slit member 12 to a plurality of measurement points on the surface of the substrate 4 via a mirror 14. A plane in which the pinholes are formed, and a plane including the surface of the substrate 4 satisfy the Scheimpflug condition for the optical system 13.

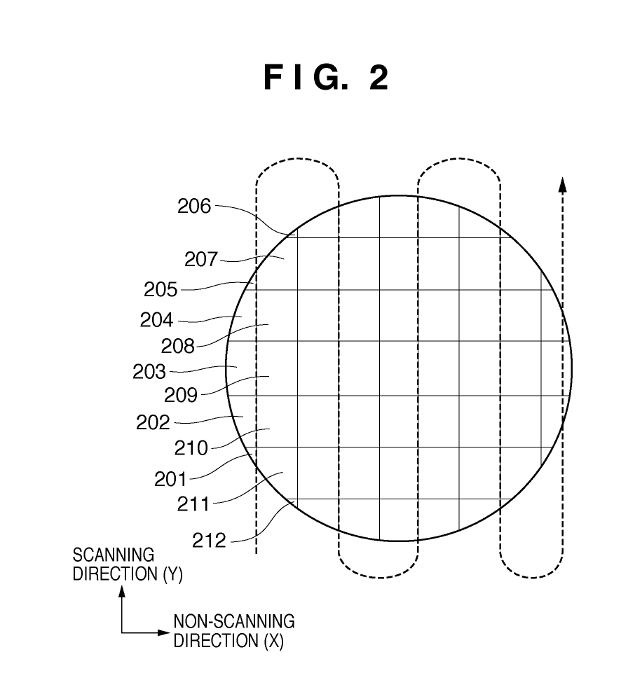

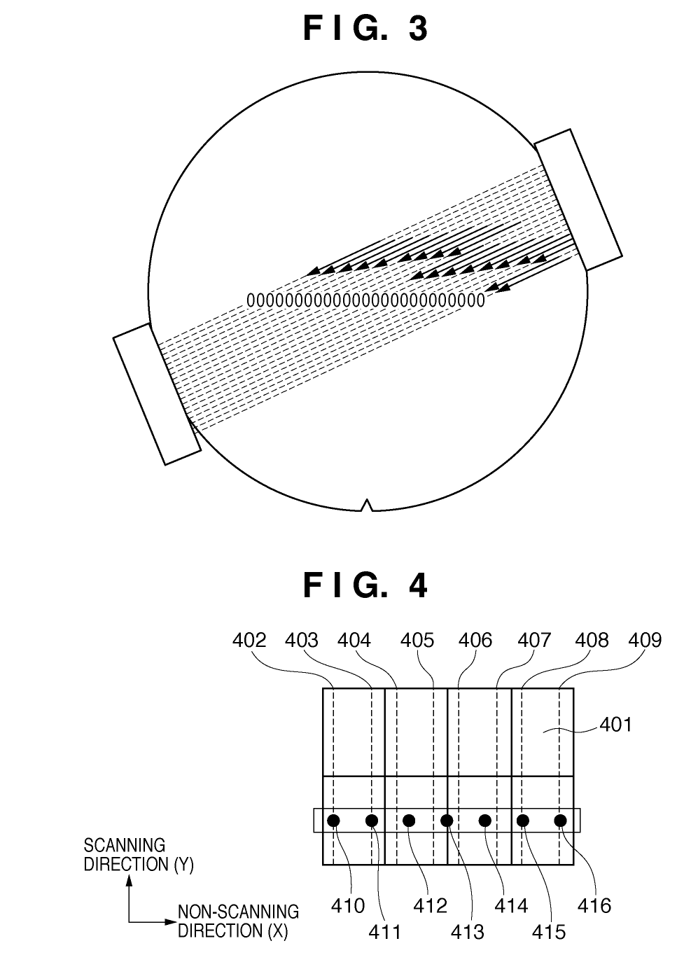

In this embodiment, an incident angle φ (the angle between a light beam and a normal to the substrate surface) at which each light beam emitted by a light irradiator including the components 10 to 14 strikes the surface of the substrate 4 is 70° or more. A plurality of shot regions having identical pattern structures are arranged on the surface of the substrate 4, as illustrated in FIG. 2. The plurality of light beams having passed through the optical system 13 reach and are reflected at the plurality of measurement points on the surface of the substrate 4, as illustrated in FIG. 3. The plurality of (in this case, 25) measurement points shown in FIG. 3 are arranged over a length nearly equal to or longer than the width of the exposure slit in the non-scanning direction in the exposure station. At least two shot regions can be measured at once by arranging 25 measurement points across a region having a width that is, for example, double that of the exposure slit in the exposure station. This shortens the time taken to measure all shot regions. The 25 light beams are guided to the 25 measurement points from a direction rotated through θ° (e.g., 22.5°) from the X direction (a scanning direction represented the numerals 6a and 22a) in the X-Y plane so that the 25 measurement points are independently observed within the plane of the substrate 4.

A bilateral telecentric light-receiving optical system 16 receives the plurality of light beams, reflected by the surface of the substrate 4, via a mirror 15. A stop 17 inserted in the light-receiving optical system 16 is common to the plurality of measurement points. The stop 17 cuts off high-order diffracted light (noise light) generated by the pattern formed on the substrate 4. The plurality of light beams having passed through the bilateral telecentric light-receiving optical system 16 again form images on the measurement surfaces of photoelectric conversion devices 19 in the form of spot light beams (pinhole images) with the same size by a plurality of separate correction lenses of correction optical systems 18. The light-receiving components 16 to 18 have undergone field tilt correction so that the plurality of measurement points on the surface of the substrate 4 are conjugate to the measurement surfaces of the photoelectric conversion devices 19. For this reason, the positions of the spot light beams never change on the measurement surfaces due to a local tilt of each measurement point. Instead, the positions of the spot light beams change on the measurement surfaces in response to a change in the surface position (a position in a direction parallel to an optical axis AX of the projection optical system 1) of the substrate 4 at each measurement point. The photoelectric conversion devices 19 can include, for example, one-dimensional line sensors or image sensors the number of which is equal to that of light beams.

The original 2 held by the original stage 3 is scanned at a constant speed in the scanning direction (Y direction) indicated by an arrow 3a shown in FIG. 1. At this time, the position of the original 2 in the non-scanning direction (X direction) perpendicular to the scanning direction indicated by the arrow 3a stays constant. A measurement device including an X-Y bar mirror 20 and interferometer 21 measures the position of the original stage 3 in the X and Y directions. The X-Y bar mirror 20 is fixed on the original stage 3. The interferometer 21 irradiates the X-Y bar mirror 20 with a laser beam.

An illumination optical system 8 can include, for example, a light source which emits pulsed light, such as an excimer laser, a beam shaping optical system, an optical integrator, a collimator, and a mirror. The illumination optical system 8 can be made of a material which efficiently transmits or reflects pulsed light in the far-ultraviolet range. The beam shaping optical system shapes the cross-sectional shape of the incident beam into a target shape. The optical integrator uniforms the distribution characteristic of a light beam and illuminates the original 2 with a uniform illuminance.

A masking blade in the illumination optical system 8 sets a rectangular illumination region with a size equal to the chip size. The pattern on the original 2 partially illuminated with the set illumination region is projected onto the substrate 4 coated with a photosensitive agent via the projection optical system 1.

The measurement device M disposed in the measurement station measures the surface position (level position) of the substrate 4 with respect to a reference surface 9 on the substrate chuck 5 mounted on the substrate stage 22 (or the substrate stage 6), and stores the measurement result in a memory 130. The reference surface 9 on the substrate chuck 5 can be formed by, for example, attaching a metallic thin film, a metallic plate, or the like to the substrate chuck 5 so that the reference surface 9 is flush with the substrate 4 in order to improve the measurement accuracy.

The substrate 4 measured in the measurement station moves to the exposure station while being held by the substrate chuck 5. A measurement device 100 measures the surface position of the substrate 4 in the direction of the optical axis AX using the reference surface 9, and adjusts this position based on the measurement result.

More specifically, the surface position of the substrate 4 can be adjusted (focused) using the reference surface 9 and a mark 23 formed in the pattern region or on its boundary line on the original 2. The mark 23 includes, for example, a pinhole. Light from the illumination optical system 8 forms an image on the reference surface 9 on the substrate chuck 5 by the projection optical system 1 upon passing through the pinhole in the mark 23. The light reflected by the reference surface 9 again forms an image in the vicinity of the mark 23 by the projection optical system 1. When the original 2 and reference surface 9 are brought into a perfect in-focus state, the amount of light which passes through the pinhole that forms the mark 23 becomes maximum. The light having passed through the pinhole that forms the mark 23 strikes a light-receiving element 26 via a half mirror 24 and condenser lens 25. A position at which the light amount measured by the light-receiving element 26 is maximum is detected while driving a Z stage of the substrate stage 6 (or the substrate stage 22), and the Z stage is positioned at the detected position.

A driver 120 drives the substrate stage 6 (or the substrate stage 22) set in the exposure station so as to expose a plurality of shot regions on the substrate 4 in the order set by a setting unit 140. Based on the information (the measurement result of the surface position of the substrate 4 with reference to the reference surface 9) which is measured in the measurement station and stored in the memory 130, the driver 120 drives the Z stage of the substrate stage so that each shot region is aligned with the image plane (in-focus position) of the projection optical system 1.

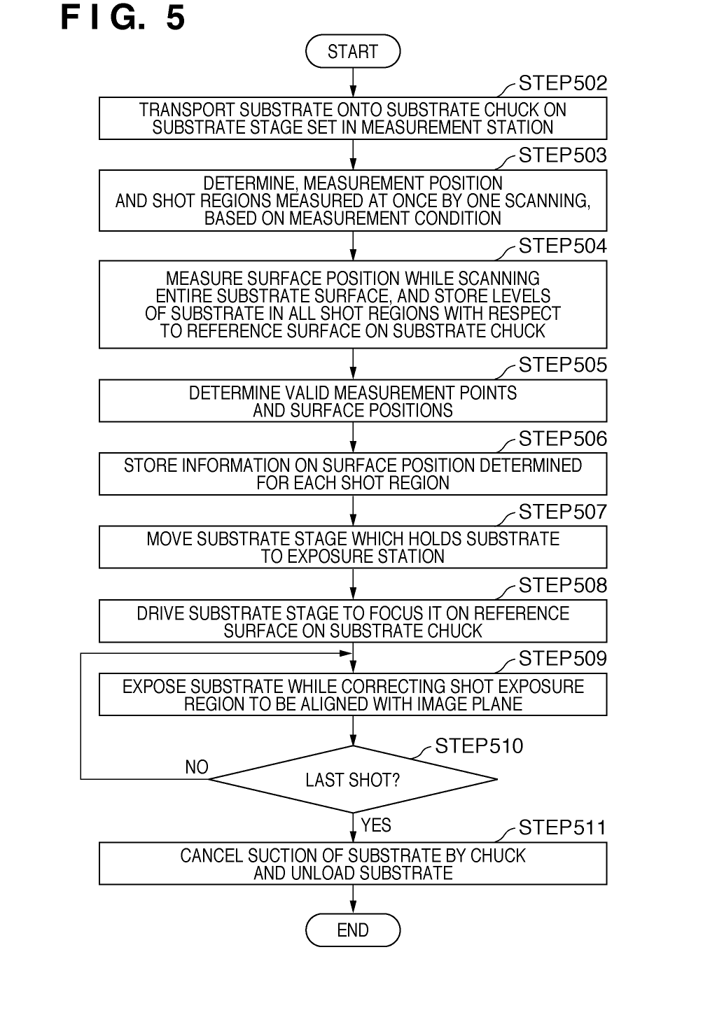

FIG. 5 is a flowchart schematically showing the operation of the scanning exposure apparatus EX shown in FIG. 1. A main controller 110 controls the operation shown in FIG. 5. Note that the main controller 110 exemplifies a controller defined in “WHAT IS CLAIMED IS”.

In step 502, the main controller 110 causes a transport hand (not shown) to transport a substrate 4 onto the substrate chuck 5 on the substrate stage 22 (or the substrate stage 6) set in the measurement station, and causes the substrate chuck 5 to hold the substrate 4.

In step 503, based on the measurement condition, the main controller 110 determines the measurement distance (or position) in each shot region, and shot regions, in the non-scanning direction, where the surface positions are measured at once by one scanning based on measurement condition. The measurement condition mentioned herein can include, for example, the arrangement distance of measurement points, the substrate size, the arrangement information of shot regions, the scanning speed, and the charge storage time of the photoelectric conversion devices 19.

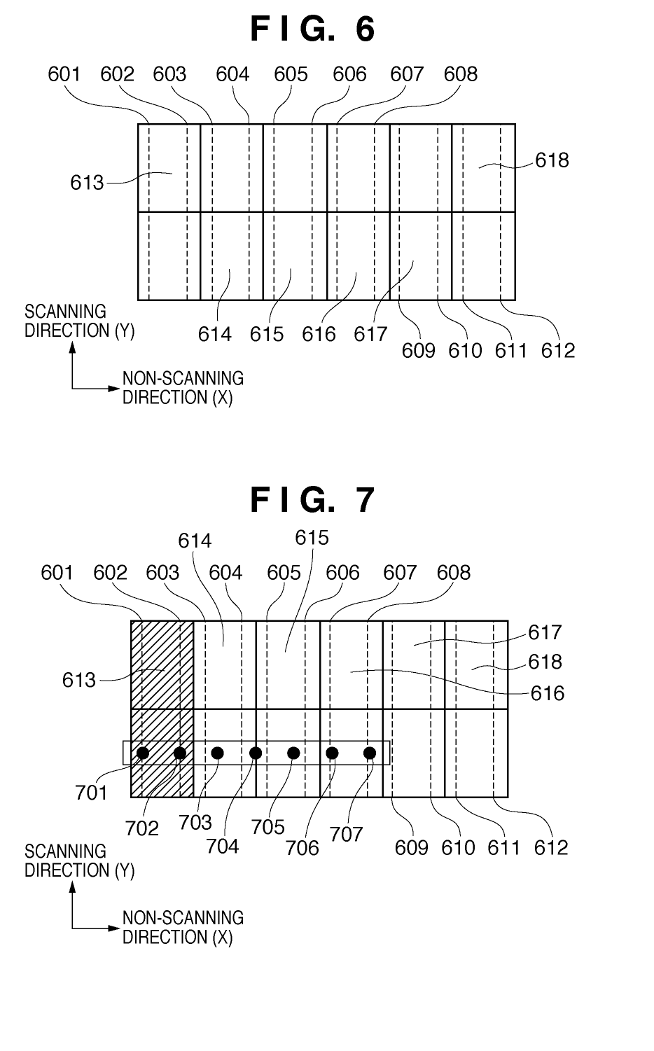

A method of determining shot regions, in the non-scanning direction, where the surface positions are measured at once by one scanning will be explained with reference to FIGS. 6 to 10.

FIGS. 6, 7, 9, and 10 illustrate a case in which the width, in the non-scanning direction (X direction), of a region 700 where measurement points 701 to 707 are arranged on the measurement device M is wider than the overall width, in the non-scanning direction, of four shot regions. Note that the non-scanning direction (X direction) is perpendicular to the scanning direction (Y direction) of a substrate during its measurement. FIG. 6 shows the relationship between measurement target positions 601 to 612 and shot region columns 613 to 618 in the arrangement of a plurality of shot regions. For example, the measurement target positions 601 and 602 in the non-scanning directions are used for the column 613, and the measurement target positions 603 and 604 in the non-scanning direction are used for the column 614.

A method of determining measurement points used when the column 613 and another column are measured at once will be explained with reference to FIG. 7. FIG. 7 shows the relationship between the measurement points 701 to 707 and the measurement target positions 601 to 612.

First, the main controller 110 determines measurement points on the measurement device M to measure the measurement target positions 601 and 602 in the column 613. This determination can be done such that the surface positions at the measurement target positions 601 and 602 are measured at the left measurement points 701 and 702 of the measurement points 701 to 707.

Next, the main controller 110 detects a column which can be measured simultaneously with measurement of the column 613. More specifically, based on the measurement target positions 603 to 612 and the positions of the measurement points 701 to 707 in the columns 614 to 618, the main controller 110 determines a column which can be measured simultaneously with measurement of the column 613 in accordance with:

|(Measurement Target Position in Non-scanning Direction)−(Position of Measurement Point in Non-scanning Direction)|≦T (1)

Note that relation (1) defines a condition for determining a measurement point at which a portion whose distance from a measurement target position falls within the tolerable distance (T) can be measured. That is, a measurement point that satisfies relation (1) is a measurement point at which a portion whose distance from a measurement target position falls within the tolerable distance (T) can be measured. A column which can be measured at a measurement point that satisfies relation (1) is a column which can be measured simultaneously with measurement of the column 613. It is to simultaneously measure all measurement target positions (or portions whose distances from the measurement target positions fall within the tolerable distance) in a column which can be measured simultaneously with measurement of the column 613. If this is not accomplished, one column may be measured by two or more times of scanning.

When relation (1) holds, the measurement target X position in a corresponding column is measured at a corresponding measurement point. That is, a column that satisfies relation (1) is measured simultaneously with measurement of the column 613.

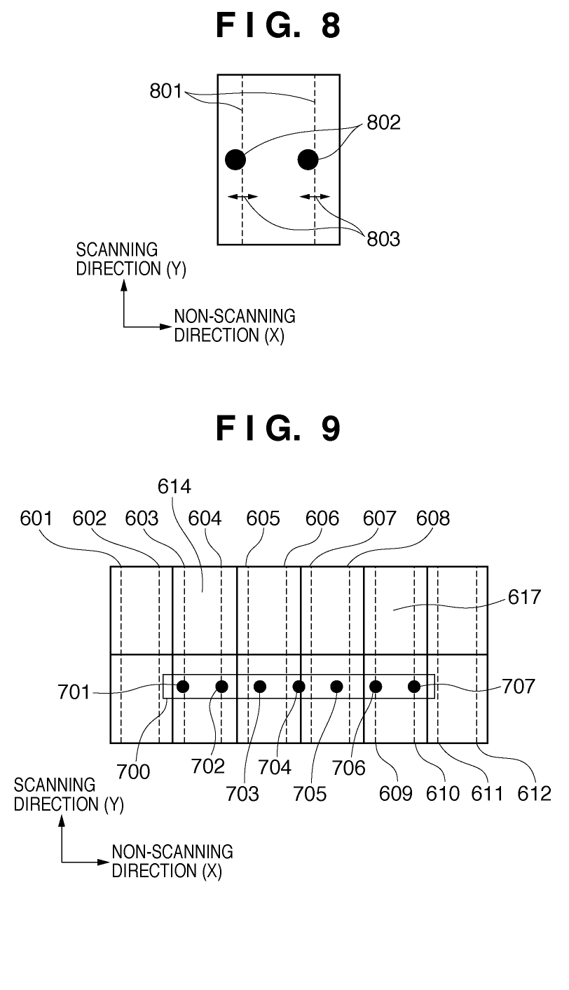

FIG. 8 is a view schematically showing the meaning of relation (1). FIG. 8 schematically shows the mutual relationship among a measurement target position 801, a measurement point 802, and a tolerable distance (T) 803 in the non-scanning direction (X direction). When the central position of the measurement point 802 is located in a region whose distance from the measurement target position 801 falls within the tolerable distance (T) 803, the substrate surface position is measured at the measurement point 802.

Referring to FIG. 7, in the column 616, the measurement points 706 and 707 satisfy relation (1) with the measurement target positions 607 and 608. Therefore, the measurement target positions 601 and 602 in the column 613, and the measurement positions 607 and 608 in the column 616 are measured at once. On the other hand, the measurement target positions in the columns 614 and 615, and 617 and 618 do not satisfy relation (1), and therefore are not targeted for simultaneous measurement.

A case in which the column 614 and another column are measured at once will be explained next with reference to FIG. 9. The main controller 110 determines measurement points on the measurement device M to measure the measurement target positions 603 and 604 in the column 614, as in the determination method used to measure the column 613. This determination can be done such that the surface positions at the measurement target positions 603 and 604 are measured at the left measurement points 701 and 702 of the measurement points 701 to 707.

Next, the main controller 110 detects a column which can be measured simultaneously with measurement of the column 614. In the example shown in FIG. 9, in the column 617, the measurement target positions 609 and 610 satisfy relation (1) with the measurement points 706 and 707. Therefore, the column 617 is measured simultaneously with measurement of the column 614.

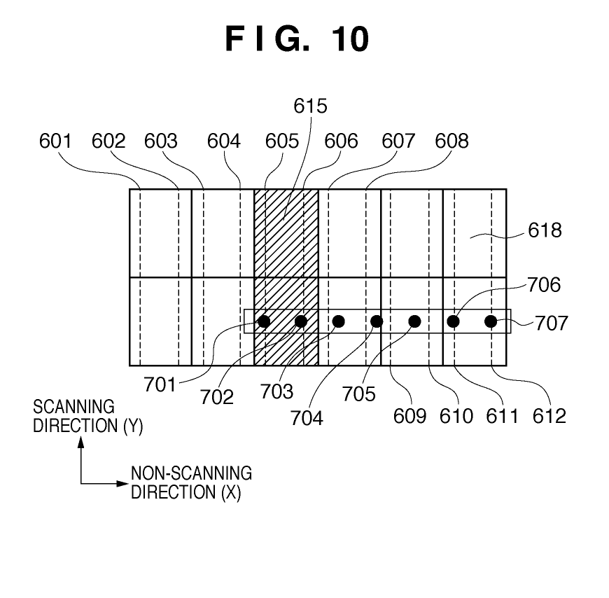

A case in which the column 615 and another column are measured at once will be explained next with reference to FIG. 10. The main controller 110 determines measurement points on the measurement device M to measure the measurement target positions 605 and 606 in the column 615, as in the determination method used to measure the column 613. This determination can be done such that the surface positions at the measurement target positions 605 and 606 are measured at the left measurement points 701 and 702 of the measurement points 701 to 707.

Next, the main controller 110 detects a column which can be measured simultaneously with measurement of the column 615. In the example shown in FIG. 10, in the column 618, the measurement target positions 611 and 612 satisfy relation (1) with the measurement points 706 and 707. Therefore, the column 618 is measured simultaneously with measurement of the column 615.

In the above-mentioned example, a plurality of columns in the arrangement of a plurality of shot regions include a first column exemplified by the column 613, a second column exemplified by the column 614, a third column exemplified by the column 616, and a fourth column exemplified by the column 617. The second column is sandwiched between the first column and the third column, and the third column is sandwiched between the second column and the fourth column. The main controller 110 can control the measurement device M so as to measure the surface positions in a shot region belonging to the first column and that belonging to the third column at once by one scanning. The main controller 110 can also control the measurement device M so as to measure the surface positions in a shot region belonging to the second column and that belonging to the fourth column at once by another one scanning.

As described above, after the main controller 110 determines a plurality of shot regions, in the non-scanning direction, measured at once by one scanning, it controls measurement by the measurement device M in step 504 (i.e., measure surface position while scanning entire substrate surface, and store levels of substrate in all shot regions with respect to reference surface on substrate chuck) of FIG. 5. At this time, the measurement device M can measure the substrate surface position in accordance with the order illustrated in FIG. 2. FIG. 2 illustrates a case in which the number of shot regions, in the non-scanning direction, measured at once by one scanning is determined as 2 or 1. “1” corresponds to the rightmost column of shot regions.

After the substrate stage reaches a constant speed upon acceleration directly before a shot region 212, measurement target positions in the shot region 212 are successively measured at their corresponding measurement points at a constant speed. Then, a plurality of shot regions in the Y direction are successively measured in the order of shot regions 201 and 211, shot regions 202 and 210, shot regions 203 and 209, shot regions 204 and 208, shot regions 205 and 207, and a shot region 206. After measurement in the shot region 206 is completed, the substrate stage immediately moves in the X direction with deceleration to a column toward the next measurement target column. After the substrate stage reaches an acceleration start point, it accelerates in the opposite direction. An operation for successively measuring a plurality of shot regions in the Y direction at a constant speed is thus repeated. This obviates the need to accelerate/decelerate the stage for each shot region, and therefore makes it possible to attain surface position measurement of the entire substrate surface in a short time. The memory 130 stores data on the measured surface position of the entire substrate surface.

In step 505, the main controller 110 determines valid measurement points and the surface positions. The valid measurement points mentioned herein are the measurement points determined in step 503 to be used to measure the surface positions in shot regions of a corresponding column. Invalid measurement points are measurement points which are not determined in step 503 to be used to measure the surface positions in shot regions of a corresponding column. When the information obtained by measurement at an invalid measurement point is stored in the memory 130, it is invalidated and discarded. The information (information representing the surface position) obtained by measurement at a valid measurement point is continuously saved in the memory 130.

In step 506, the main controller 110 determines the surface positions in respective shot regions based on the pieces of information obtained by measurement at valid measurement points, and stores them in the memory 130.

In step 507, the main controller 110 moves the substrate stage (and the substrate held by it) from the measurement station to the exposure station.

In step 508 (e.g., drive substrate stage to focus it on reference surface on substrate chuck), based on the mark 23 and the reference surface 9 on the substrate chuck 5, the main controller 110 adjusts the level of the Z stage so that the reference surface 9 is aligned with the image plane of the projection optical system 1.

In step 509, the substrate is exposed while each shot region is aligned with the image plane of the projection optical system 1, based on the information which represents the substrate surface position (level position) with reference to the reference surface 9 on the substrate chuck 5 and is stored in the memory 130, under the control of the main controller 110.

In step 510 (last shot?), the main controller 110 checks whether exposure in all shot regions on the substrate is ended. If exposure in all shot regions is not ended (NO in step 510), the process returns to step 509. On the other hand, if exposure in all shot regions is ended (YES in step 510), the substrate is unloaded from the exposure station in step 511 (i.e., cancel suction of substrate by chuck and unload substrate), and a series of exposure sequence is ended. A device manufacturing method according to an embodiment of the present invention can be used to manufacture devices such as a semiconductor device and a liquid crystal device. The method can include a step of exposing a substrate coated with a photosensitive agent using the above-mentioned scanning exposure apparatus, and a step of developing the exposed substrate. The device manufacturing method can also include known subsequent steps (e.g., oxidation, film formation, vapor deposition, doping, planarization, etching, resist removal, dicing, bonding, and packaging).

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2008-285706, filed Nov. 6, 2008, which is hereby incorporated by reference herein in its entirety.

What is claimed is:

1. An apparatus which includes a measurement device that measures a surface position of a substrate at each of a plurality of measurement points; which is configured to scan and expose the substrate using slit-shaped light while controlling the surface position based on the measurement result; and in which a width, in a non-scanning direction of the substrate, of a region where the plurality of measurement points are arranged is wider than a width of the slit-shaped light, the apparatus comprising:
a controller configured to control the measurement device so as to measure the surface positions in at least two shot regions on the substrate at once at the measurement points, at each of which a portion whose distance from a measurement target position on the substrate falls within a tolerable distance can be measured, of the plurality of measurement points.

2. The apparatus according to claim 1, wherein the non-scanning direction is perpendicular to a scanning direction of the substrate.

3. The apparatus according to claim 1, wherein the controller determines the measurement points, and controls the measurement device so as to measure the surface positions in at least two shot regions at once at the determined measurement points.

4. The apparatus according to claim 1, wherein
a plurality of columns in an arrangement of the plurality of shot regions include a first column, a second column, a third column, and a fourth column, the second column is sandwiched between the first column and the third column, and the third column is sandwiched between the second column and the fourth column.

5. The apparatus according to claim 4, wherein
the controller controls the measurement device so as to measure the surface positions in a shot region belonging to the first column and a shot region belonging to the third column at once by one scanning, and to measure the surface positions in a shot region belonging to the second column and a shot region belonging to the fourth column at once by another one scanning.

6. The apparatus according to claim 1, wherein the controller invalidates information obtained by measurement at a measurement point, at which a portion whose distance from the measurement target position doesn't fall within the tolerable distance, of the plurality of measurement points.

7. A method for an apparatus which includes a measurement device that measures a surface position of a substrate at each of a plurality of measurement points; which is configured to scan and expose the substrate using slit-shaped light while controlling the surface position based on the measurement result; and in which a width, in a non-scanning direction of the substrate, of a region where the plurality of measurement points are arranged is wider than a width of the slit-shaped light, comprising:
determining measurement points, at each of which a portion whose distance from a measurement target position on the substrate falls within a tolerable distance can be measured, of the plurality of measurement points; and
controlling the measurement device so as to measure the surface positions in at least two shot regions on the substrate at once at the determined measurement points.

8. A method comprising:
exposing a substrate using an apparatus; and
developing the exposed substrate,
wherein the apparatus includes a measurement device that measures a surface position of a substrate at each of a plurality of measurement points and is configured to scan and expose the substrate using slit-shaped light while controlling the surface position of the substrate based on the measurement result; and in which a width, in a non-scanning direction of the substrate, of a region where the plurality of measurement points are arranged is wider than a width of the slit-shaped light, the apparatus comprising:
a controller configured to control the measurement device so as to measure the surface positions in at least two shot regions on the substrate at once at measurement points, at each of which a portion whose distance from a measurement target position on the substrate falls within a tolerable distance can be measured, of the plurality of measurement points.

9. The method according to claim 8, wherein the non-scanning direction is perpendicular to a scanning direction of the substrate.

10. The method according to claim 8, wherein the controller determines the measurement points, and controls the measurement device so as to measure the surface positions in at least two shot regions at once at the determined measurement points.

11. The method according to claim 8, wherein
a plurality of columns in an arrangement of the plurality of shot regions include a first column, a second column, a third column, and a fourth column, the second column is sandwiched between the first column and the third column, and the third column is sandwiched between the second column and the fourth column.

12. The method according to claim 11, wherein
the controller controls the measurement device so as to measure the surface positions in a shot region belonging to the first column and a shot region belonging to the third column at once by one scanning, and to measure the surface positions in a shot region belonging to the second column and a shot region belonging to the fourth column at once by another one scanning.

13. The method according to claim 8, wherein the controller invalidates information obtained by measurement at a measurement point, at which a portion whose distance from the measurement target position doesn't fall within the tolerable distance, of the plurality of measurement points.

14. The method according to claim 7, wherein the non-scanning direction is perpendicular to a scanning direction of the substrate.

15. The method according to claim 7, wherein the controller determines the measurement points, and controls the measurement device so as to measure the surface positions in at least two shot regions at once at the determined measurement points.

16. The method according to claim 7, wherein
a plurality of columns in an arrangement of the plurality of shot regions include a first column, a second column, a third column, and a fourth column, the second column is sandwiched between the first column and the third column, and the third column is sandwiched between the second column and the fourth column.

17. The method according to claim 16, wherein
the controller controls the measurement device so as to measure the surface positions in a shot region belonging to the first column and a shot region belonging to the third column at once by one scanning, and to measure the surface positions in a shot region belonging to the second column and a shot region belonging to the fourth column at once by another one scanning.

18. The method according to claim 7, wherein the controller invalidates information obtained by measurement at a measurement point, at which a portion whose distance from the measurement target position doesn't fall within the tolerable distance, of the plurality of measurement points.
